(19) United States
(12) Patent Application Publication
(10) Pub. No.: US 2017/0240380 A1
(43) Pub. Date: Aug. 24, 2017

(54) EVACUATION CONCEPT FOR ELEVATOR SYSTEMS

(71) Applicants: ThyssenKrupp Elevator AG, Essen (DE); ThyssenKrupp AG, Essen (DE)

(72) Inventor: Günter Reuter, Filderstadt (DE)

(73) Assignees: ThyssenKrupp Elevator AG, Essen (DE); ThyssenKrupp AG, Essen (DE)

(21) Appl. No.: 15/518,198

(22) PCT Filed: Oct. 7, 2015
(86) PCT No.: PCT/EP2015/073110

§ 371 Date: Apr. 24, 2017

(30) Foreign Application Priority Data
Oct. 10, 2014 (DE) 10 2014 220 633.2

(51) Int. Cl. B66B 5/02; B66B 11/02

(52) U.S. Cl. CPC B66B 5/027; B66B 11/0226; B66B 2201/30

(57) ABSTRACT

An elevator system may include a plurality of cars that are disposed vertically one above another in a common shaft. The plurality of cars may be independently movable. Further, the plurality of cars may include evacuation devices that permit the passage of passengers from a car to be evacuated into an adjacent car that is disposed vertically above or below the car to be evacuated. In some cases, an evacuation device of an uppermost car of the plurality of cars includes an opening floor hatch, and an evacuation device of a lowermost car of the plurality of cars includes an opening roof hatch.

### DESCRIPTION

The present invention concerns an elevator system in which a plurality of cabins or cars which are disposed vertically one above the other can be moved independently from one another in a common shaft. The invention moreover describes an evacuation method for such an elevator system.

Elevator systems in which a plurality of cars which are disposed vertically one above the other can be moved independently from one another in a common shaft are known. Each car has its own drive unit. Typically, a lower car is carried by traction cables running at the side along the upper car. By providing an appropriate elevator control system, which maintains a certain minimum distance between the cars, a safe operation of such an elevator system can be assured, in particular making it possible to prevent collisions between the cars. Such elevator systems can also encompass more than two cars disposed one above the other and able to be moved independently from one another in an elevator shaft.

Each elevator system needs to be provided with an evacuation device, which ensures that passengers in one elevator car which has come to a standstill between two floors following an unintentional halt caused by an operational fault can be taken to a suitable floor, especially the nearest floor. One possible reason for coming to such a standstill can be, for example, a malfunction of a corresponding drive unit.

The European standards EN 81-1/2 and EN 81-20/50 provide various options for the evacuating of passengers from elevators with large distances between the stopping points when a car is blocked or comes to an unwanted stop between two floors: first, an evacuation through emergency doors provided in the shaft wall is possible. In this case, emergency doors must be provided at maximum vertical distances of 11 m, through which trapped people can be evacuated. Moreover, in the case of cars which can travel in a common shaft next to each other (horizontally), an evacuation is possible through emergency crossover doors provided in the side walls of the cars from a blocked or stalled car to an operational car which is brought up to it at the side.

The North American standard ASME provides for an evacuation through the roof of a car to the roof of the car of such an adjacent elevator. For this purpose, corresponding hatches are provided in the car roof.

Traditional evacuation concepts based on emergency doors in the shaft are seen as a disadvantage for many reasons. For example, it is very costly, especially in the case of rather tall buildings, to provide emergency doors for each shaft at the mentioned distances. Moreover, such emergency doors have to be accessible from the outside, i.e., from the building side. This leads to a restriction of the design freedom of the architect. Moreover, such emergency doors constitute a breach in the static strength of the building.

The currently known evacuation concepts through emergency crossover doors also have various drawbacks. In general, such an evacuation is only possible with group shafts, in which cars can be moved alongside each other. Moreover, these evacuation concepts lead to limitations in the arrangement of counterweights, for example. An evacuation through emergency crossover doors is difficult, for example, when the emergency crossover door of a blocked car finds itself next to shaft cross beams. Moreover, passengers in such an evacuation concept have to cross over the “abyss” between two adjacent cars, which may constitute a psychological obstacle to many passengers. It also proves to be a drawback that the required structural space for an emergency crossover door entails a relatively large car depth.

A crossover via roofs of cars positioned horizontally alongside each other also has various drawbacks. First of all, the passengers need to get onto the roof of the blocked car. In a second step, once again the “abyss” has to be crossed to an adjacent car roof. Furthermore, the available space on a car roof is very limited on account of the arrangement of various elevator components. Moreover, it proves to be impractical that side banisters provided on a car roof have to be removed before the crossing.

An evacuation device for elevators with elevator cars able to be moved horizontally alongside each other in a common shaft is known from EP 0 212 147 E1.

In so-called multicar systems, where at least two cars disposed vertically one above another are able to be moved independently from one another in a common shaft, the above-described evacuation concepts cannot be effectively realized.

For example, such systems on account of the operation of a plurality of cars vertically one above another in the same shaft (i.e., the same railway) have a significantly larger delivery capacity than traditional elevator systems. If one car gets stuck in such a shaft, firstly the delivery capacity of this railway becomes blocked. If the adjacent railway for an evacuation to a car set off to the side also becomes blocked in such a case, the delivery capacity of the elevator system as a whole collapses catastrophically.

Moreover, such elevator systems have a costly cable guidance using suspension and compensation ropes. For example, in a multicar system with two cars which can travel independently from one another, traditionally two sections of the traction means (e.g., suspension rope) and two sections of the compensation rope run beside the upper car. Moreover, guide rails also run at the side of the cars. In the case of an evacuation to a car positioned horizontally adjacent, such ropes and guide rails represent obstacles which it is hard for passengers to overcome.

The same difficulties occur during an evacuation over the roof of a car to a car positioned at the side of the car to be evacuated.

Neither can the described evacuation concepts be used with advantage in multicar elevators having a linear drive unit. For example, in these cases a lot of structural space for one or more stators is needed along the entire delivery height, in addition to the cars. The rotors of the linear motors arranged on the cars also curtail the available space. On the whole, the space required to realize, for example, an evacuation into a parallel movable car would be very large.

The present invention therefore strives to provide an easily realized evacuation concept for elevator systems in which several cars disposed vertically one above another can be moved independently from each other in a common shaft.

This problem is solved by an elevator system with the features of patent claim 1 as well as a method with the features of patent claim 13.

With the elevator system according to the invention, an evacuation is possible within a single railway without affecting the operation of adjacent railways.

According to a preferred embodiment of the elevator system according to the invention, the plurality of cars which are disposed vertically one above the other can be moved independently from one another in a common shaft by means of an elevator control system, wherein the elevator control system is designed such that in a first operating mode a first minimum distance between the respective cars is maintained, and in a second operating mode a second minimum distance, being less than the first minimum distance, is maintained. The first operating mode here corresponds to the normal operation of the elevator system. The first minimum distance is chosen here such that a safe operation of the elevator system is possible under normal operating conditions. The second operating mode here corresponds to an emergency or evacuation operating mode, in which passengers have to be evacuated from a blocked car, and for this purpose another car situated vertically above or below the car to be evacuated is brought up to the car to be evacuated. Only a slight minimum distance needs to be maintained for this, such as 1 m, 1.50 m or 2 m. The collision safety in this case can be assured, inter alia, in that the other cabin is brought up to the car to be evacuated only at a reduced speed as compared to the normal operation.

Advisedly, the evacuation device has an opening floor hatch for an uppermost car, and an opening roof hatch for a lowermost car. In the event that two cars which are able to be moved independently from one another are arranged one above another in a shaft, an evacuation from the uppermost car to the lower car or vice versa can be achieved in this way by opening the respective hatches.

In the event that more than two cars which are able to be moved independently from one another are provided one above another in a shaft, the evacuation devices of the cars which are arranged between the uppermost car and the lowermost car advisedly comprise a roof hatch and a floor hatch, so that an evacuation is possible into both a lower and an upper adjacent car.

Passengers being evacuated do not have to leave the projection surface of the cars according to these embodiments. In particular, no crossing of an abyss between two cars able to be moved in parallel with each other (i.e., horizontally spaced apart) is necessary. In this way, the psychological stress on passengers involved in an evacuation is greatly diminished as compared to traditional solutions. The safety and guidance of passengers is much more easily accomplished in this case as compared to traditional systems with the horizontal crossing of an abyss.

According to another embodiment, the evacuation devices of the cars each comprise at least one opening door in at least one of their side walls. In particular, these are special evacuation doors, being arranged on the cars in addition to the customary car doors. The evacuation doors thus are set off from the shaft doors of the elevator system and cannot be used for entry and exit in normal operation.

Especially preferably, in the case of all embodiments, the evacuation devices of at least some of the cars comprise at least one crossover device. In particular, one may consider here telescopically extending crossover devices, by which different distances between two adjacent cars can be bridged in event of an evacuation. It is conceivable to provide or place such crossover devices in operation automatically in event of an evacuation. It is possible to design each of the cars with such a crossover device. However, it is also conceivable, especially in the case of crossover elements which serve for the evacuation through side doors, to design these as being vertically movable in the shaft. For example, one or two such crossover devices could be stowed in the shaft head and/or in the shaft pit and be moved vertically within the shaft as needed.

In the case of doors provided in side walls of the cars for the evacuation, the passengers being evacuated can step from such a door onto a crossover device which is provided at the side outside of the car and step up or down via the crossover device onto a vertically spaced-apart car which has been brought up, there being provided a corresponding opening door in the car brought up.

Advisedly, the crossover devices are designed as ladders. Preferably, such ladders have side protection elements, so that passengers to be evacuated have a side protection when climbing up or down on such ladders. Such side protection elements, as well as the ladders themselves, can be designed with rungs. It is likewise conceivable to use side lattice elements or wall elements here.

According to one specially preferred embodiment of the elevator system according to the invention, the cars are designed with suspension means and weight compensation means, especially suspension ropes and compensation ropes, which are moved at least partly along the cars at the side. Such suspension means can be operated in especially advantageous manner by means of a traction drive, which provides on the whole a very robust and reliable elevator system. The concept according to the invention of an evacuation from a car to be evacuated into another car situated above or below that car without crossing the car projection surface proves to be especially favorable in such elevator systems, since the suspension means and compensation ropes running alongside a car to be evacuated do not pose a problem during the evacuation.

Advisedly, the cars in the elevator system according to the invention can be moved along vertically running guide rails. Such guide rails likewise run at the side of the respective cars. Neither do these guide rails present any obstacle during the evacuation according to the invention.

The problems resulting from rope guides and guide rails at the side of the cars in the event of emergency crossover doors in the side walls of the cars can be almost entirely avoided.

The side walls of the car can be configured in very simple manner.

As regards the method according to the invention, it is pointed out that the respective steps can be performed, as one chooses, either automatically, for example, initiated by the elevator control system, or by initiation of the rescue forces. Advisedly, corresponding sensors or recognition devices are provided for recognizing that an evacuation situation is at hand, these being connected to the elevator control system.

The switching from a first operating mode to a second operating mode can likewise occur automatically. However, it is also conceivable for rescue forces or some other suitable person to send a corresponding control command to the elevator control system. The same holds for the bringing up of a car to the car being evacuated. This can either be done automatically or by manual control.

As a rule, the opening of a floor hatch or a roof hatch is done by the rescue forces. However, it is also possible here to provide an automatic opening by means of an appropriate drive unit. The providing and placing in operation of at least one crossover device is likewise generally done manually, by the rescue forces. Here as well, an automatic positioning by appropriate drive units is conceivable.

Further advantages and embodiments of the invention will emerge from the description and the enclosed drawing.

Of course, the abovementioned features and those yet to be described below can be used not only in the particular indicated combination, but also in other combinations or standing alone, without leaving the scope of the present invention.

The invention is represented schematically by means of an embodiment in the drawing and shall be described in detail below, making reference to the drawing.

### DESCRIPTION OF FIGURES

The invention shall be described in more detail below, with the aid of sample embodiments represented in the drawing.

There are shown:

FIG. 1 a schematic side view of an elevator system with two cars disposed one above the other and able to be moved independently from one another according to the prior art,

FIG. 2 a schematic cross section along line A′A in FIG. 1,

FIG. 3 a schematic longitudinal section of an elevator system with three cars disposed one above the other and able to be moved independently from one another according to a first preferred embodiment of the invention,

FIG. 4 a schematic longitudinal section of an elevator system with three cars disposed one above the other and able to be moved independently from one another according to a second preferred embodiment of the invention,

FIG. 5 a schematically simplified perspective drawing of the embodiment as per FIG. 4, and

FIG. 6 a schematic simplified cross section of a car which can be used for the second embodiment, in which possible positions of doors in side walls are represented.

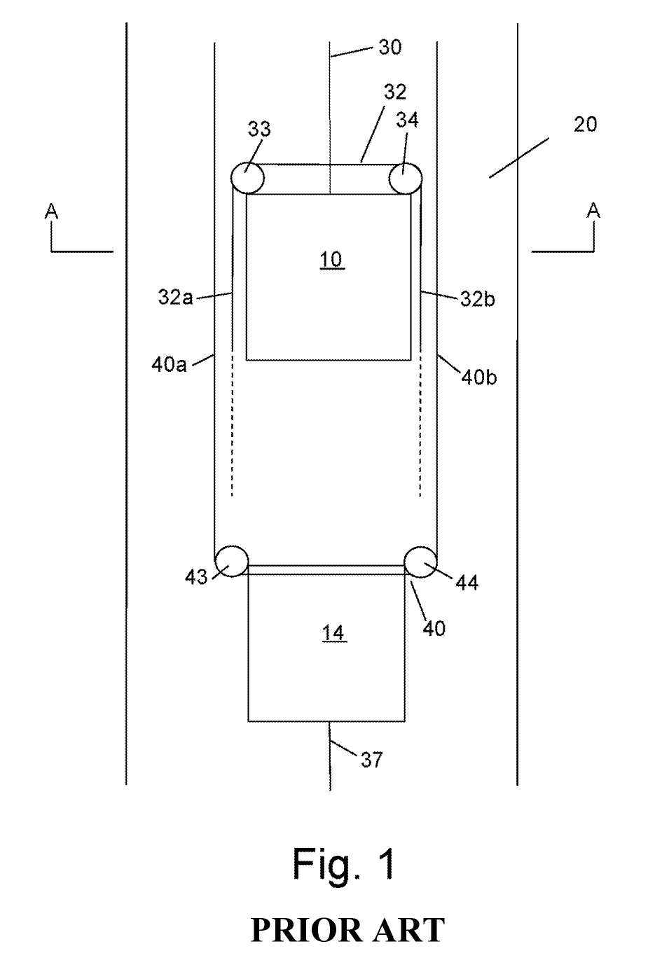

FIG. 1, in order to explain the invention, represents first of all an elevator system according to the prior art with two cars 10, 14 disposed one above the other and able to be moved independently from one another in a shaft 20. The invention can be advantageously used in such an elevator system. The upper car 10 can be moved by means of a first drive, not shown, and the lower car 14 by means of a second drive, not shown. It is assumed that both drives involve a traction drive. The first car 10 is moved with the aid of a suspension means 30. The suspension means 30 is led across a drive pulley of the first drive, not shown, and connected to a first counterweight, likewise not shown in FIG. 1. To balance out the weight of the suspension means 30, the first car 10 moreover comprises a compensation rope 32, which is led across deflection rollers 33, 34 and, running downward from the car 10 (shown by broken line), connected likewise to the first counterweight across a deflection means, not shown, which is provided in the pit of the shaft 20.

As can be seen from FIG. 1, the compensation rope 32 here runs along opposite side walls of the first car, while the rope sections respectively taken along opposite walls are designated as 32a and 32b.

In order to ensure the independent movement of the cars 10 and 14, the lower car 14 can travel with the aid of a suspension means 40, which is led outside of the travel path of the upper car 10. For this purpose, the second suspension means 40 is led across rollers 43, 44 formed on the lower car 14 outside of the upper car 10 and the compensation rope 32. The suspension means 40 is thus likewise led along the two opposite sides of the upper car 10, on which the compensation rope 32 is also led. The corresponding sections of the suspension means 40 are designated as 40a, 40b. A compensation rope of the car 14 is likewise partly shown and designated as 37. On the whole, this rope guidance enables an independent traveling of the cars 10, 14 in the shaft 20.

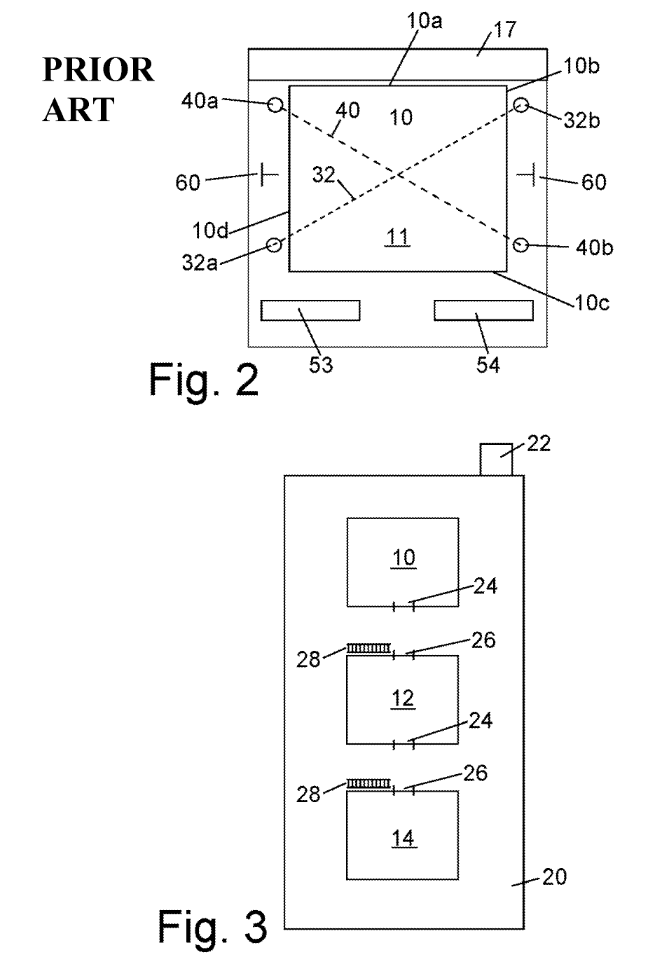

The rope guidance situation resulting from this rope guidance, e.g., at the level A-A of the upper car 10, is shown schematically in FIG. 2.

In addition to the mentioned ropes and rope sections 32a, 32b, 40a, 40b running vertically in the shaft, guide rails 60 of the upper car 10 are also shown schematically here. Moreover, the stretches of the suspension means 40 and the compensation rope 32 underneath and above the car are shown by broken line for the purposes of illustration. The respective counterweights for the lower and upper car are moreover shown schematically and designated as 52, 53. A door (not shown) of the car is provided at the side of the car 10 opposite the counterweights 52, 54. A shaft door is shown schematically and designated as 17.

The side walls or side boundaries of the car 10, together defining a car projection surface 11, are designated as 10a-10d. The other cars have a corresponding car projection surface.

As can be seen in FIG. 2, during a sideways evacuation of passengers from the car 10 across the sides 10b or 10d, the stretches of the suspension means and ropes must be taken into account. The counterweights 52, 54 can travel at the back side of the car 10. These need to be taken into account during an evacuation across the side 10c.

Referring to FIG. 3, the concept of the invention for vertical evacuation, i.e., evacuation from a car being evacuated into another car positioned vertically above or below that car, is explained with the aid of a first sample embodiment.

In FIG. 3 one recognizes three cars 10, 12, 14 disposed vertically one above another and able to be moved independently from one another. The cars can be moved with the aid of a shared elevator control system 22. For sake of simplicity, none of the drives or suspension means or compensation ropes are shown here. It is likewise possible to provide a control system for each car.

The upper car 10 is designed with a floor hatch 24. The middle car 12 is designed with a floor hatch 24 and a roof hatch 26. Moreover, a ladder 28 is provided on the roof of the car 12 as a crossover device in event of an evacuation.

The lower car 14 comprises a roof hatch 26 and a ladder 28.

In a first operating mode, the cars 10, 12, 14 are able to move independently from one another in the shaft 20. In the first operating mode (normal operation), a minimum distance is maintained between the respective cars 10, 12, 14, such as four meters.

Let it now be assumed that the elevator control system 22 recognizes that, for example, the middle car 12 is blocked or stuck in the shaft 20 and the passengers present in the car 12 need to be evacuated. The elevator control system 22 now switches to a second operating mode (evacuation mode). This switching can be done either by an attendant, or be generated automatically.

In the second operating mode, the upper car 10 for example is brought up in a special travel mode, such as one with slower speed than in normal operation, to the middle car 12 being evacuated. In the second mode, a reduced minimum distance is maintained, such as a minimum distance of 1.5 m or 2 m.

In the following, let it be assumed that a specially trained rescue team is present in the upper car 10. However, it is likewise possible for the now ensuing evacuation process to occur with no such rescue team, under observance of certain safety criteria. For example, a fully automatic performance of the individual steps to prepare for the evacuation is possible, during which appropriate instructions can be displayed to the persons being evacuated via a display provided in the car or communicated via a loudspeaker device.

The rescue team opens a floor hatch 24 provided in the floor of the upper car 10. Using a first crossover means, which can be kept on hand for example in the car 10 or in another suitable place, the rescue team descends onto the roof of the car 12 being evacuated.

At the same time, it is possible to turn on a lighting which lights up the space between the upper car 10 and the car 12 being evacuated. Advisedly, the light is in the form of a beam, so that no view is possible into the non-illuminated shaft (i.e., outside of the projection surface of the cars). The rescue team or another suitable person informs the passengers being evacuated as to the opening of the roof hatch 26 of the car 12 being evacuated.

After opening the roof hatch 26, the rescue team positions a second crossover means 28, which is kept on hand for example on the roof of the car 12, and make their way down into the blocked car.

After appropriate instructing of the passengers being evacuated, they are evacuated one at a time via the second crossover means 28 onto the roof of the car 12 and then via the first crossover means into the upper car 10. Advisedly, the passengers are safeguarded in this process by the rescue team or teams.

Next, the first crossover means is again dismantled and the floor hatch 24 of the upper car is closed. The passengers can now be taken in a special travel mode to the next evacuation station in the upper car 10.

Depending on the number of passengers, these evacuation steps may need to be repeated until all passengers have been evacuated from the car being evacuated 12.

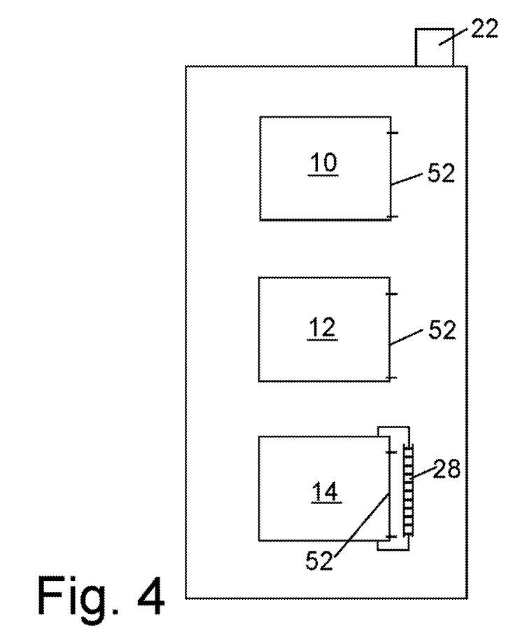

In FIGS. 4 to 6, a second embodiment of the invention is explained in which an evacuation is done through doors which are provided in the side walls of the cars.

FIG. 4 corresponds substantially to FIG. 3, each car 10, 12, 14 being designed with a side door which can be opened for the evacuation. A crossover device 28 designed as a ladder is shown schematically for the car 14. Advisedly, each of the cars 10, 12, 14 is designed with such a crossover device 28. The positioning of this crossover device (or these devices) 28 can be done in suitable manner during the normal operation of the elevator system. For example, it is possible to provide the crossover device 28 on the outer wall or inner wall of the corresponding side wall of the car in which the door 52 is fashioned. It would likewise be conceivable to stow the crossover device 28 on the roof or the floor of the car.

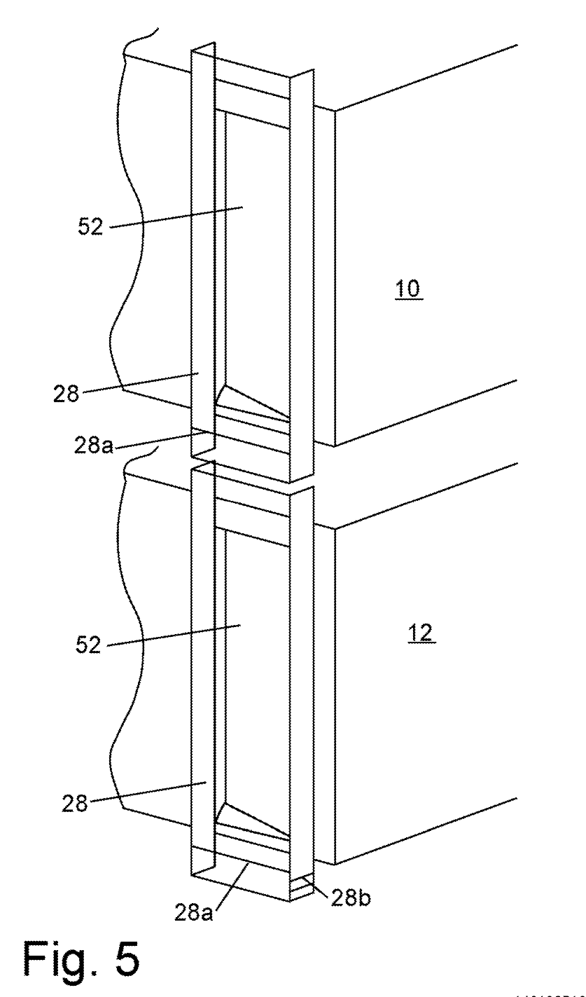

FIG. 5 shows in simplified perspective view two cars positioned vertically one above the other and brought up to one another while maintaining a minimum distance provided for an evacuation situation (called the second minimum distance in the claims). Each of the cars 10, 12 is designed with a crossover device 28 in the form of a ladder. It should be noted that, for reasons of clarity, only certain rungs 28a of the ladder are shown.

Preferably, the crossover elements 28 have side protection elements 28b, which can likewise be fashioned as rung or lattice elements. On the whole, after opening a door 52 provided in a side wall of the car 12, a passenger being evacuated finds a space bounded by rungs or similar elements, within which he can use the rungs 28a to climb up into the car 10 brought up above to the car 12 being evacuated (in the example shown). The car 10 comprises a corresponding crossover element 28, which is aligned with the crossover element 28 of the car 12. Using the crossover element 28 of the car 10, the passenger can then easily enter the car 10 through the opened door 52.

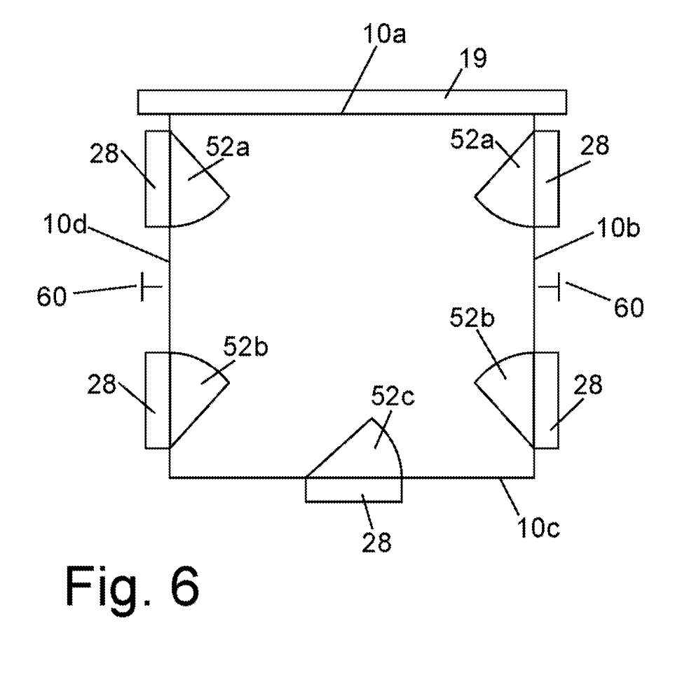

FIG. 6 shows possible positions of such side doors. The reference numbers here are chosen similar to FIG. 2. In addition, a schematically depicted car contour is designated as 19. A shaft door is not shown here in detail. At the side walls 10b, 10d, the doors (looking out from the car 14) can be formed either in front of or behind the guide rails 60. The doors 52 arranged in front of the guide rails 60 are designated as 52a, those behind the guide rails as 52b. It is likewise possible to arrange such a door in the back side 10c of the car. A corresponding door is designated as 52c.

Crossover devices associated with the respective doors 52a, 52b, 52c are each denoted as 28. In this perspective, the boxlike construction of a ladder correspondingly provided with side walls or side rungs, for example, can be especially well seen.

As noted with regard to FIG. 2, such an arrangement of side doors 52a, 52b, 52c requires, e.g., a corresponding positioning of the suspension means and counterweights. For example, it is conceivable to design the counterweights 53, 54 correspondingly more narrow and longer, as represented in FIG. 2, when providing a door 52c, so that the door 52c or the associated crossover device 28 can be arranged between these counterweights.

1-26. (canceled)

27. An elevator system wherein a plurality of cars are disposed vertically one above another and are independently movable in a common shaft, wherein the plurality of cars include evacuation devices that allow passengers to move from one of the plurality of cars to be evacuated into an adjacent car of the plurality of cars that is disposed vertically above or below the one of the plurality of cars to be evacuated.

28. The elevator system of claim 26 further comprising an elevator control system, wherein the plurality of cars are independently movable in the common shaft by way of the elevator control system, wherein the elevator control system is configured such that
in a first operating mode a first minimum distance between the plurality of cars is maintained, and
in a second operating mode a second minimum distance between the plurality of cars is maintained, wherein the second minimum distance is less than the first minimum distance.

29. The elevator system of claim 26 wherein an evacuation device of an uppermost car of the plurality of cars includes an opening floor hatch, wherein an evacuation device of a lowermost car of the plurality of cars includes an opening roof hatch.

30. The elevator system of claim 26 wherein the plurality of cars includes more than two cars, wherein the evacuation devices for the plurality of cars disposed between an uppermost car and a lowermost car comprise a roof hatch and a floor hatch.

31. The elevator system of claim 26 wherein the evacuation devices of the plurality of cars comprise at least one opening door in at least one side wall.

32. The elevator system of claim 26 wherein the evacuation device of at least one of the plurality of cars comprises at least one crossover device.

33. The elevator system of claim 32 wherein the at least one crossover device has a telescopically-extending design.

34. The elevator system of claim 32 wherein the at least one crossover device is configured to move vertically in the common shaft independently of the plurality of cars.

35. The elevator system of claim 32 wherein the at least one crossover device is configured as a ladder.

36. The elevator system of claim 35 wherein the at least one crossover device comprises side protection elements.

37. The elevator system of claim 26 wherein the plurality of cars include suspension means and weight compensation means that are moved at least partly along sides of the plurality of cars.

38. The elevator system of claim 26 further comprising vertically running guide rails, wherein the plurality of cars are movable along the vertically running guide rails.

39. A method for evacuating passengers from a first car of an elevator system that comprises the first car and a second car, wherein the first and second cars are disposed vertically above one another and are movable independently of one another in a common shaft, the method comprising:
identifying an evacuation situation wherein the first car is to be evacuated;
switching from a first operating mode in which a first minimum vertical distance is maintained between the first and second cars to a second operating mode in which a second minimum vertical distance is maintained between the first and second cars, wherein the second minimum vertical distance is less than the first minimum distance;
positioning the second car adjacent to the first car while maintaining the second
minimum vertical distance; and
either
opening a floor hatch or a roof hatch of the first car, opening a roof hatch or a floor hatch of the second car that is vertically opposite the opened floor or roof hatch of the first car, and deploying at least one crossover device for crossing between the opened hatches of the first and second cars, or
opening a door disposed in a side wall of the first car, opening a corresponding door of the second car, and deploying a crossover device for crossing between the opened doors of the first and second cars.
